(19) United States
(12) Patent Application Publication
(10) Pub. No.: US 2019/0185972 A1
(43) Pub. Date: Jun. 20, 2019

(54) SINTERED CEMENTED CARBIDE GRANULATE AND ITS USE

(71) Applicant: FRAUNHOFER-GESELLSCHAFT ZUR FOERDERUNG DER ANGEWANDTEN FORSCHUNG E.V., Muenchen (DE)

(72) Inventor: Johannes POETSCHKE, Dresden (DE)

(73) Assignee: FRAUNHOFER-GESELLSCHAFT ZUR FOERDERUNG DER ANGEWANDTEN FORSCHUNG E.V., Muenchen (DE)

(21) Appl. No.: 16/179,033

(22) Filed: Nov. 2, 2018

(30) Foreign Application Priority Data
Nov. 3, 2017 (DE) 10 2017 125 734.9

(51) Int. Cl. C22C 29/08; C22C 29/00; B33Y 70/00; C23C 4/06

(52) U.S. Cl. CPC C22C 29/08; C22C 29/005; B33Y 10/00; C23C 4/06; B33Y 70/00

(57) ABSTRACT

The invention is concerned with the fields of cemented carbide materials and ceramic and/or powder-metallurgical process engineering and relates to a sintered cemented carbide granulate such as that which can, for example, be used for the production of wear parts or tools with cemented carbides, and to its use.

The object of the present invention is to specify a cemented carbide granulate with which cemented carbide green bodies and cemented carbide sintered bodies that exhibit a high green density and high green strength can be produced, and to specify the use thereof.

The object is attained with a sintered cemented carbide granulate which, for the majority of granules, has an inhomogeneous distribution of hard material and metallic binder in the individual granule, wherein the concentration of the metallic binder at the surface of the individual granule is, in total, at least 25% greater than in the interior of the granule.

The invention is concerned with the fields of cemented carbide materials and ceramic and/or powder-metallurgical process engineering and relates to a sintered cemented carbide granulate such as that which can, for example, be used for the production of wear parts or tools with cemented carbides, and to its use.

The production of cemented carbide bodies, which in the green state contain the raw cemented carbide powder in addition to organic binders, by means of pressing methods, extrusion, or MIM/CIM and subsequent sintering is known from the prior art. Cemented carbide parts with a differing composition can thereby be produced.

With these known production methods, there are restrictions in regard to the geometry of the parts that are to be produced, which restrictions cannot be eliminated with these technologies.

For design freedom in the production of complex cemented carbide parts, the use of additive manufacturing methods is required. In manufacturing methods of this type, the parts are created according to a 3D model, which is generated with a computer, in that the 3D model is essentially cut into thin slices and the part is then produced slice-by-slice.

One such additive manufacturing method is what is referred to as 3D binder jetting. Powder or presintered cemented carbide granulate is thereby applied in layers on a base, and is locally cemented together according to the layers of the computer model by means of a binder jetting liquid.

Once the entire part has been completed by means of a layer-by-layer application of powder/granulate and binder jetting liquid, the loose powder or granulate is removed if necessary after a post-curing of the binder, and the resulting green body is subjected to a debinding and sintering process.

The successful use of a 3D binder jetting of this type for cemented carbide parts with a high metallic binder content of over 19 vol % is known (J. Pötschke et al.: Additive Manufacturing Of Hardmetals, Euro PM2017 Proceedings (ISBN:978-1-899072-47-7)).

Parts with a lower metallic binder content of ≤19 vol % have not been previously possible by means of 3D binder jetting, since the known commercial cemented carbide powders/granulates exhibit too low of a bulk density and cannot be further compressed. An increased compression could only be achieved through a higher metallic binder content, since when cemented carbide green bodies with low green densities are compressed, significant material rearrangements must take place which can primarily be achieved by the fusing of the components. In the case of cemented carbides, only the metallic components fuse, as a result of which the material rearrangements can only be achieved with a high metallic binder content.

In addition, in the case of conventional commercial cemented carbide powders/granulates, the achievable green body is not strong enough after the debinding to be subsequently handled and/or post-processed (sintering).

A disadvantage of this method is that the parts often fall apart during the subsequent sintering of the parts, since the powder particles and in particular the presintered cemented carbide granules are no longer in contact with one another as a result of the removal of the organic binders in the heat treatment process (debinding), and the shape of the part thus cannot be maintained, or can no longer be fully maintained.

With other additive manufacturing methods, a higher strength of the green body can already be achieved with a local direct energy input, such as by means of laser sintering, for example ((Y. Xiong et al.: Powder Metallurgy Vol. 53, Iss. , 2010; T. Gläser, Untersuchungen zum Lasersintern von Wolframcarbid-Kobalt, Dissertation 2010; Generative Fertigung von Extrusionswerkzeugen aus Hartmetall-GENIAL (BMBF)).

In laser sintering, very high temperatures are sometimes required, particularly in order to allow the presintered cemented carbide granules to be sintered together primarily with the layers of presintered cemented carbide granules located thereunder. Because it is often not possible to achieve this to an adequate extent, damage to the cemented carbide structure frequently occurs in this method, particularly since excessively high local energy inputs in turn lead to a decomposition of the tungsten carbide in the cemented carbide granules or, in the presence of cobalt and/or nickel, an undesired eta phase can form.

Presintered and partially compressed cemented carbide granulates of WC—Co, Cr₃C₂—Ni are known, for example, from Faisal, N.H. et al.: J. Therm. Spray Tech. (2011) 20, 1071; S.M. Nahvi et al.: Surface and Coatings Techn., (2016) 286, 95-102; G. Bolelli et al.: Surface and Coatings Techn. (2012) 206, 4079-4094).

Furthermore, a 3D printing of cermets or carbide hard materials is known from WO2017/178319 A1. According to this document, 65-85 wt % porous carbide hard materials or hard materials are mixed with 15-435 wt % dense carbide hard materials or hard materials, and this powder mixture is used for the 3D printing of green bodies, which are then sintered.

Also, a method for producing hard materials or carbide hard material powders is known from WO2015/162206 A2, in which method a powder of dense and spherical carbide hard material granules comprising a metal, a hard material, and an organic binder is mixed with sintering aids and is subsequently sintered.

A disadvantage of the solutions from the prior art is that, when presintered cemented carbide granules are used, cemented carbide green bodies often cannot be produced with adequate green density and strength.

The object of the present invention is to specify a cemented carbide granulate with which cemented carbide green bodies and cemented carbide sintered bodies that exhibit a high green density and high green strength can be produced, and to specify the use thereof.

The object is attained by the invention disclosed in the claims. Advantageous embodiments are the subject matter of the dependent claims.

In the sintered cemented carbide granulate according to the invention, which has an inhomogeneous distribution of hard material and metallic binder in the individual granule for the majority of granules, the concentration of the metallic binder at the surface of the individual granule is, in total, at least 25% greater than in the interior of the granule.

Advantageously, WC, TiC, TiCN, NbC, TaC, Cr₃C₂, VC, and/or Mo₂C, and/or mixtures thereof are present as hard materials.

Likewise advantageously, Co, Fe, and/or Ni, and/or mixtures thereof are present as metallic binders.

Also advantageously, additives of Cr₃C₂, VC, and/or TaC are present in the granules as grain growth inhibitor.

And also advantageously, the hard material is present with an average grain size of 0.05 to 7 μm in the cemented carbide granules.

It is also advantageously, if the concentration of the metallic binder at the surface of the individual granule is, in total, 25% to 2000% greater than in the interior of the granule.

It is likewise advantageous if the distribution of the metallic binder at the surface is as uniform as possible across the entire surface of the individual granule.

It is furthermore advantageous if the metallic binder is present in the form of a most complete possible surface layer on the individual granules.

The use according to the invention of cemented carbide granulate sintered according to the invention takes place for additive manufacturing methods and/or for thermal spraying.

Advantageously, the use takes place for powder bed-based additive manufacturing methods, such as 3D powder printing (binder jetting) or selective laser sintering/melting or electron beam melting.

With the solution according to the invention, it becomes possible to specify for the first time cemented carbide granulate with which cemented carbide green bodies and cemented carbide sintered bodies can be produced which exhibit a high green density and sinter density and high green strength and sinter strength, and to specify its use for methods that were not previously applicable for cemented carbide granulates.

According to the invention, this is achieved by sintered cemented carbide granulate in which, for the majority of granules, an inhomogeneous distribution of hard material and metallic binder is present in the individual granule. It is thereby particularly important that this inhomogeneous distribution is present such that the metallic binder thereby has a concentration of the metallic binder at the surface of the individual granule that is, in total, at least 25% greater than the concentration of the metallic binder in the interior of the granule.

With these total concentration specifications, it is on the one hand defined that there is a clear concentration difference between the interior and the surface of the granule with regard to the metallic binder. On the other hand, it is thus also defined that the metallic binder does not need to be located on the surfaces in a homogeneous distribution.

With the cemented carbide granulates according to the invention, it is achieved by means of the arrangement of the metallic binder phase in a higher total concentration at the surface that, in the locations at which the cemented carbide granules exhibit a considerably higher concentration of metallic binder at the surface during the subsequent processing by means of additive manufacturing methods, whereby during a temperature increase significantly more melt phase is present at the surface of the granules and as a result an improved sintering of the cemented carbide granules is achieved on the one hand, the sintering can also be carried out at lower temperatures and/or for shorter times, and in addition, the total metallic binder concentration in the granules can also be further reduced.

With this sintered cemented carbide granulate according to the invention, significantly lower temperatures can be used for the fabrication of the green bodies and sintered bodies from this granulate, since at lower temperatures it already leads, as a result of the partial melting and fusing of the metallic binder and the formation of sintering necks, to a partial sintering which results in the significantly improved green density and green strength.

Through the use of the cemented carbide granulate according to the invention, the use of lower sintering temperatures and/or for shorter times also becomes possible for the simultaneous or subsequent complete sintering of the parts.

Since the metallic binder of the cemented carbide granules according to the invention is present at the surface in the concentration according to the invention, the thermal conductivity of the individual granules is also improved, so that a rapid sintering is therefore also possible at lower sintering temperatures. If the cemented carbide granules according to the invention are used in laser sintering, the energy input can thus also be significantly reduced.

WC, TiC, TiCN, NbC, TaC, Cr₃C₂, VC, and/or Mo₂C, and mixtures thereof can for example be present as hard materials of the cemented carbide granules according to the invention, and Co, Fe, and/or Ni, and mixtures thereof can for example be present as metallic binders.

Furthermore, additives of Cr₃C₂, VC, and/or TaC can be present in the granules as grain growth inhibitor.

The average grain size of the hard materials in the cemented carbide granules is advantageously in the range of 0.05 to 7 μm.

Advantageously, the concentration of the metallic hinder at the surface of the individual granule is, in total, 25% to 2000% greater than in the interior of the granule.

it is also advantageous if the distribution of the metallic hinder at the surface takes place as uniformly as possible across the entire surface of the individual granule, and if the metallic binder is present in the form of a most complete possible surface layer on the individual granules.

In this manner, the cohesion of the hard material present in the granule is also achieved.

The cemented carbide granulates according to the invention are advantageously present at granule sizes of 5 μm to 90 μm.

The granulation and partial compression can, for example, be achieved using the spray technology/fluidized bed approach, or with a mechanical agglomeration/granulation. The further compression of the cemented carbide granules can be achieved with a subsequent partial or complete sintering of the granules, advantageously followed by a deagglomeration.

The cemented carbide granulate according to the invention can also result from a coating of partially or fully compressed granules that have been formed by means of spray granulation and a subsequent partial or complete sintering. After deagglomeration and classification of the granules by means of screening and separating, the granulate is coated with the metallic binder, such as Co, Ni, Fe, or mixtures thereof, for example, by means of physical vapor deposition/plasma-enhanced chemical vapor deposition (PVD/PECVD).

Another possibility for the production of cemented carbide granulate according to the invention is the control of the sintering bonds of the heat treatment process.

The granules are thereby produced from a milled mixture of hard material, metallic binder, and pressing aids using spray granulation or fluidized bed granulation, and a diffusion of the metallic binder onto the surface of the granules is achieved by setting a carbon gradient with increased carbon in the interior of the granules. The setting of the carbon gradient can be carried out, for example, by means of a rapid debinding at, for example, 20 K/min to 800 ° C. without a holding time.

Alternatively, the concentration of metallic binder at the surface can also be achieved by means of a hydrogen treatment during the sintering.

Furthermore, the concentration of the metallic binders at the surface can be achieved by controlling the cooling rate during the sintering of the cemented carbide granules in the three-phase range of WC, Co liquid, and C solid.

According to the invention, the sintered cemented carbide granulate according to the invention is used for additive manufacturing methods and/or for thermal spraying. The additive manufacturing methods can be, for example, powder bed-based methods, such as 3D powder printing (binder jetting) or selective laser sintering/melting or electron beam melting.

Parts made from the hard material granulates according to the invention can have a greater degree of geometric freedom and, at the same time, a high stability of said parts as green bodies. The decomposition of the hard materials or the formation of undesired phases due to excessive energy input can also be avoided.

The invention is explained below in greater detail with the aid of several exemplary embodiments.

### EXAMPLE 1

Sintered cemented carbide granulate was produced by a milling and mixing of WC, Co, Cr₃C₂, and 2 mass % organic binder, in this case paraffin, in heptane, a subsequent spray granulation, and a sintering at 1200° C. The granules were then deagglomerated and screened into the fraction ≤90 μm. The fraction ≥10 μm and ≤32 μm was then obtained by means of conventional separating technology.

The cemented carbide granulate presintered in such a manner comprised 19 vol % Co and WC distributed homogeneously in the granules, with an initial grain size of 0.75 μm d_{FSSS}.

The presintered and separated cemented carbide granulate was, in a further sintering, briefly heated to 1345° C. and then cooled to 1200° C. at a cooling rate of 0.5 K/min. After a cooling to room temperature (approx. 20° C.), the granulate was once again deagglomerated and separated.

Following production, the surface of the granules was 50% covered with cobalt, wherein the concentration of cobalt at the surface was, in total, then 263% greater than the original cobalt content in the interior of the granules.

### EXAMPLE 2

Sintered cemented carbide granulate was produced by a milling and mixing of WC, 16 vol % (equal to 10 mass %) Co, and 2 mass % organic binder, in this case paraffin, in heptane, a subsequent spray granulation, and a sintering at 1200° C. in a sinter-HIP furnace. The granules were then deagglomerated and screened into the fraction ≤90 μm. The fraction ≥10 μm and ≤32 μm was then obtained by means of conventional separating technology.

The granulate presintered in this manner was then transferred to a PVD coating system and kept in motion by means of a vibrating table adapted for the powder coating. The coating took place at 5*10⁻³ mbar with an adapted power output (DC voltage) at room temperature. The cobalt target had a surface structuring specifically suited to magnetic materials.

Following coating, the surface of the granules was 90% covered with cobalt, wherein the cobalt content at the surface in the coated state was, in total, 565% higher than the cobalt content in the interior of the granules.

### EXAMPLE 3

Sintered cemented carbide granulate was produced by a milling and mixing of WC, 16 vol % (equal to 10 mass %) Co, 0.5 mass % Cr₃C₂, and 2 mass % organic binder, in this case paraffin, in heptane, a subsequent spray granulation, screening to <90 μm, and a sintering in very thin bulk in a vacuum sinter furnace at approx. 1320° C. with a very slow cooling rate of 0.5 K/min to 1150° C., wherein metallic binder was pressed to the surface.

Following production, the surface of the granules was 75% covered with cobalt, wherein the cobalt content at the surface was, in total, then 468% greater than the original cobalt content in the interior of the granules.

### EXAMPLE 4

Sintered cemented carbide granulate was produced by a milling and mixing of WC, 16 vol % (equal to 10 mass %) Co, 0.5 mass % Cr₃C₂, and 2 mass % organic binder, in this case paraffin, in heptane, a subsequent spray granulation, screening to <90 μm, and a debinding with a subsequent sintering to 1290° C. For the debinding in an N2—Ar mixture, a very high heating rate of 20 K/min to 800° C. without a holding time was thereby used, so that the organic binder present was only removed in the edge region of the granules and the carbon content in the interior thus increased as a result of the decomposition of the organic binder, which caused a diffusion of the metallic binder to surface during the sintering.

Following production, the surface of the granules was 80% covered with cobalt, wherein the cobalt content at the surface was, in total, then 500% greater than the original cobalt content in the interior of the granules.

1. A sintered cemented carbide granulate which, for the majority of granules, has an inhomogeneous distribution of hard material and metallic hinder in the individual granule, wherein the concentration of the metallic binder at the surface of the individual granule is, in total, at least 25% greater than in the interior of the granule.

2. The sintered cemented carbide granulate according to claim 1 in which WC, TiC, TiCN, NbC, TaC, Cr₃C₂, VC, and/or Mo₂C, and/or mixtures thereof are present as hard materials.

3. The sintered cemented carbide granulate according to claim 1 in which Co, Fe, and/or Ni, and/or mixtures thereof are present as metallic binders.

4. The sintered cemented carbide granulate according to claim 1 in which additives of Cr₃C₂, VC, and/or TaC are present in the granules as grain growth inhibitor.

5. The sintered cemented carbide granulate according to claim 1 in which the hard material is present with an average grain size of 0.05 to 7 μm in the cemented carbide granules.

6. The sintered cemented carbide granulate according to claim 1 in which the concentration of the metallic binder at the surface of the individual granule is, in total, 25% to 2000% greater than in the interior of the granule.

7. The sintered cemented carbide granulate according to claim 1 in which the distribution of the metallic binder at the surface is as uniform as possible across the entire surface of the individual granule.

8. The sintered cemented carbide granulate according to claim 7 in which the metallic binder is present in the form of a most complete possible surface layer on the individual granules.

9. A use of sintered cemented carbide granulate according to claim 1 for additive manufacturing methods and/or for thermal spraying.

10. The use according to claim 9 for powder bed-based additive manufacturing methods, such as 3D powder printing (binder jetting) or selective laser sintering/melting or electron beam melting.
